(19) United States
(12) Patent Application Publication
(10) Pub. No.: US 2019/0220850 A1
(43) Pub. Date: Jul. 18, 2019

(54) Systems and Methods for Use in Pairing Electronic Wallets

(71) Applicant: MASTERCARD INTERNATIONAL INCORPORATED, Purchase, NY (US)

(72) Inventors: Ryan B. J. Crowe, New York, NY (US); Stephen Boldt, Franklin Park, NJ (US); Matthew Billard, New York, NY (US); Khaled Mohamed, Brooklyn, NY (US); Sina Jazayeri, New York, NY (US); George Rodríguez, Fair Lawn, NJ (US)

(21) Appl. No.: 15/869,682

(22) Filed: Jan. 12, 2018

(51) Int. Cl. G06Q 20/36; G06Q 20/32

(52) U.S. Cl. CPC G06Q 20/36; G06Q 20/322

(57) ABSTRACT

Systems and methods are provided for pairing an electronic wallet for a consumer with a service provider. One exemplary method includes receiving, by a computing device, a request to pair the electronic wallet with the service provider where the electronic wallet is associated with an account and where the account is associated with a user, and requesting, by the computing device, consent from the user to pair the electronic wallet with the service provider. The method also includes generating, by the computing device, a pairing token for the wallet application and the service provider upon consent from the user, and storing the pairing token in association with the wallet application, whereby the service provider is permitted to use the pairing token in a subsequent network transaction involving an entity associated with the service provider and the wallet application, regardless of whether the wallet application is separately paired with the entity.

### FIELD

The present disclosure generally relates to systems and methods for use in pairing electronic wallets with service providers, and in particular, for facilitating network transactions with entities associated with the service providers, based on the pairing of the electronic wallets with the service providers.

### BACKGROUND

This section provides background information related to the present disclosure which is not necessarily prior art.

Consumers are known to purchase products (e.g., goods or services, etc.) from merchants. The consumers are further known to fund purchase transactions for the products through payment accounts. The consumers may present the payment accounts, in connection with the transactions, by providing credit cards or debit cards to the merchants, or by presenting digital wallets (e.g., virtual wallets, etc.). In response, the merchants are able to compile and direct authorization requests for the transactions to issuers of the payment accounts. In so doing, the authorization requests may initially be directed to acquirer banks associated with the merchants, or to payment service providers (PSPs) associated with the merchants and/or issuers. Regardless, when the issuers approve the transactions, the merchants are able to continue in the transactions and deliver the products to the consumers. It is further known that, when the consumers interact with the merchants, at virtual merchant locations such as websites, the consumers may store payment account numbers or other credentials, associated with their payment accounts, with the merchants. The merchants are then able to recall the credentials in connection with subsequent purchases so that the consumers are not required to re-enter payment account credentials repeatedly. Other information associated with the consumers, such as, for example, shipping addresses and contact information, may also be maintained at the merchants for later use in transactions.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in pairing an electronic wallet for a consumer with a payment service provider and, also, with one or more merchants associated with the payment service provider;

FIG. 2 is a block diagram of a computing device that may be used in the exemplary system of FIG. 1;

FIG. 3 is a flow diagram of an exemplary method, which may be implemented in connection with the system of FIG. 1, for pairing an electronic wallet for a consumer with a payment service provider;

FIG. 4 is a flow diagram of an exemplary method, which may be implemented in connection with the system of FIG. 1, for facilitating a payment account transaction based on a token associated with an electronic wallet paired with a payment service provider; and

FIG. 5 is a flow diagram of another exemplary method, which may be implemented in connection with the system of FIG. 1, for facilitating a payment account transaction based on a token associated with an electronic wallet paired with a payment service provider.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Merchants rely on payment service providers (PSPs) to permit consumers to participate in payment account transactions with the merchants. PSPs, in turn, provide payment services to multiple different merchants in connection with such transactions. When the consumers interact with the merchants, online, for example, the consumers are forced to have multiple different profiles with the different merchants, each potentially associated with payment account credentials, whereby the consumers are able to purchase products through the merchants (using the different corresponding profiles) with the underlying transactions then processed by the PSPs.

Uniquely, the systems and methods herein permit consumers to pair electronic wallets, for example, with the PSPs, whereby payment account credentials included in the electronic wallets are usable at different merchants associated with the PSPs (without requiring multiple different profiles with the different merchants). In particular, a consumer may understand that a PSP is associated with multiple merchants, and desire to initiate payment account transactions with one or more of the multiple merchants. To do so, the consumer pairs his/her electronic wallet with the PSP. Specifically, a pairing request is sent, via a merchant (e.g., at a website, etc.), to the PSP. The PSP, in turn, provides a request to a wallet platform associated with the consumer's electronic wallet, which is passed to the consumer via the electronic wallet (at a communication device associated with the consumer). When the consumer consents, the wallet platform generates and provides a token to the PSP. Then, later, when the consumer attempts a purchase at the merchant, the consumer selects the electronic wallet option for payment, whereby the token is validated and used by the wallet platform to request, from the consumer, the payment account, shipping address, etc. for the transaction. The wallet platform then passes the identified transaction data to the PSP to submit the transaction for processing. In this manner, the electronic wallet (and one or more payment accounts therein) may be paired to a single PSP, whereby multiple merchants associated with the PSP may each be “paired” to the electronic wallet for efficient and convenience payment account transactions.

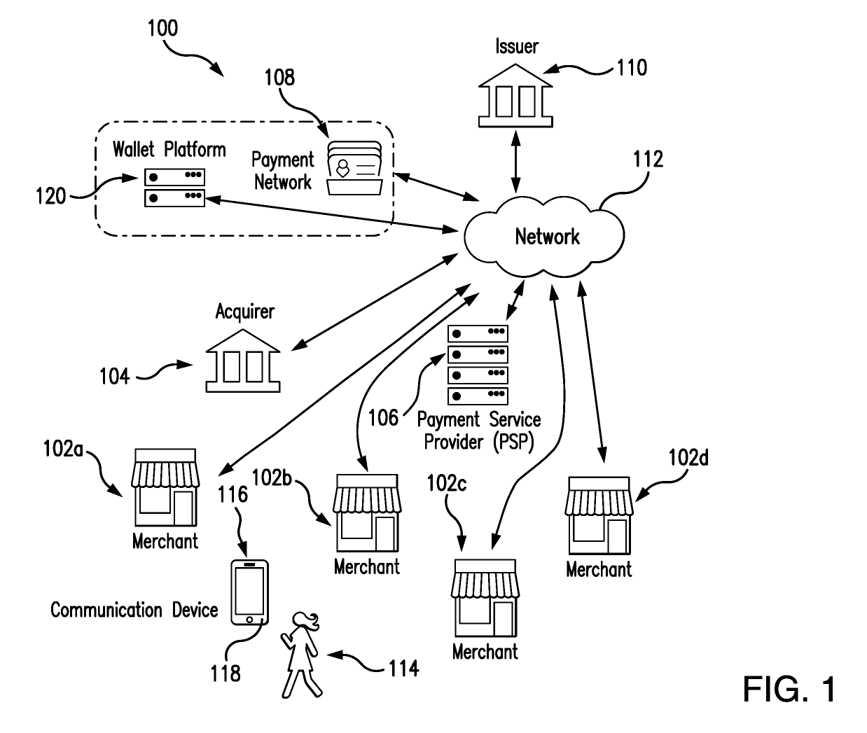

FIG. 1 illustrates an exemplary system 100 in which one or more aspects of the present disclosure may be implemented. Although the system 100 is presented in one arrangement, other embodiments may include the parts of the system 100 (or other parts) arranged otherwise depending on, for example, manners of payment for products purchased from merchants, manners of shipping products to consumers, etc.

The system 100 generally includes four merchants 102a-d, an acquirer 104, a payment service provider (PSP) 106, a payment network 108, and an issuer 110 configured to issue payment accounts (or other accounts) to consumers, each of which is coupled to (and is in communication with) network 112. The network 112 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 112 may include multiple different networks, such as a private payment transaction network made accessible by the payment network 108 to the acquirer 104 and the issuer 110 and, separately, the public Internet, which may provide interconnection between the merchants and one or more consumers (e.g., consumer 114, etc.), etc.

In general herein, each of the multiple merchants 102a-d offers products (e.g., goods, services, etc.) for sale to consumers, including to the consumer 114, etc. The merchants 102a-d may offer goods for sale through physical locations or through virtual locations, etc. For purposes of the description herein, each of the merchants 102a-d offers produces for sale through one or more virtual locations (not shown) (e.g., through network-based applications, websites, etc.), etc. As such, the consumer 114, for example, is permitted to browse the virtual locations and, when appropriate, select one or more products for purchase. While only four merchants 102a-d are illustrated in FIG. 1 for ease of illustration, it should be appreciated that any number of merchants may be included in other system embodiments.

In the illustrated embodiment, each of the multiple merchants 102a-d is associated with the PSP 106. In connection therewith, the PSP 106 includes a service for accepting electronic payments on behalf of the multiple merchants 102a-d, whereby the PSP 106 acts as a gateway for the merchants 102a-d (e.g., for transactions performed at the virtual locations of the merchants 102a-d, etc.). The PSP 106 may be incorporated and/or integrated, for example, with the virtual locations of the merchants 102a-d so that the PSP 106 is invoked (e.g., via an application programming interface (API), etc.) upon the consumer's request to checkout at the respective one of the multiple merchants 102a-d (e.g., when the consumer 114 selects a checkout icon at a website associated with one of the merchants 102a-d, etc.).

The consumer 114 in the system 100 is associated with a payment account issued by the issuer 110. The payment account may be a credit account, a debit account, or other suitable type of account for use as described herein. The consumer 114 has the option to use one or more different types of payment devices to convey, for example, payment account credential(s) associated with the payment account to one of the multiple merchants 102a-d in connection with purchase transactions at the merchants 102a-d. For example, the consumer 114 may present a conventional credit card payment device when purchasing a product. The consumer 114 is also associated with a communication device 116. The communication device 116 includes a wallet application 118, which is an electronic wallet (also referred to as a virtual wallet or digital wallet). The consumer's payment account, in turn, is included in the wallet application 118, such that the wallet application 118 is also usable to cause payment account transactions to be funded by the consumer's payment account issued by the issuer 110.

As further shown in FIG. 1, the system 100 includes a wallet platform 120 (e.g., a digital acceptance network (switch), etc.). The wallet platform 120 is associated with the wallet application 118 at the consumer's communication device 116, and is configured to perform as a “backend” for the wallet application 118 to facilitate operations described herein. The wallet platform 120 may be a stand-alone part of the system 100, or it may be incorporated into or associated with the payment network 108 (in whole or in part), as indicated by the dotted box in FIG. 1. It should be appreciated that the wallet platform 120 may further (or alternatively) be associated with and/or incorporated into the issuer 110 or otherwise in the system 100 in other embodiments.

While four merchants 102a-d, one acquirer 104, one PSP 106, one payment network 108, and one issuer 110 are illustrated in FIG. 1, it should be appreciated that any number of these entities (and their associated components) may be included in the system 100, or may be included as a part of systems in other embodiments, consistent with the present disclosure. Likewise, it should be appreciated that the system 100 is not limited to only one consumer 114, as numerous consumers will likely be included in various implementations of the systems and methods described herein. As such, the system 100 may accommodate multiple transactions similar to the ones described herein.

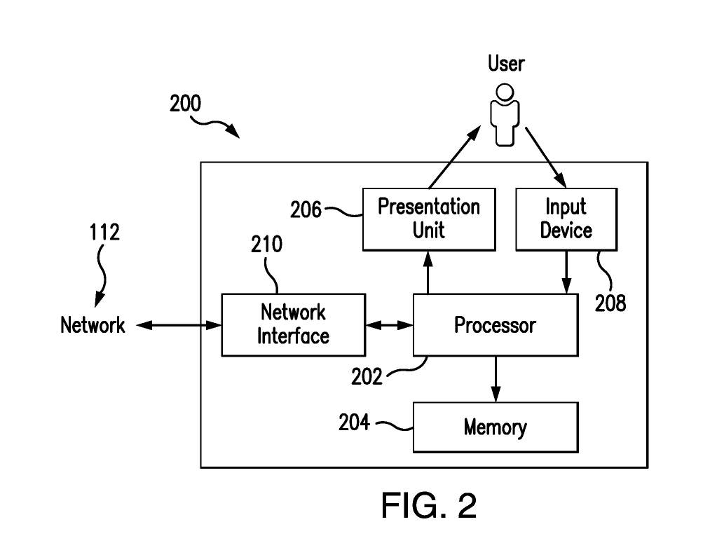

FIG. 2 illustrates an exemplary computing device 200 that can be used in the system 100. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In the exemplary embodiment of FIG. 1, the merchant 102a-d, the acquirer 104, the PSP 106, the payment network 108, and the issuer 110 may each include, or be implemented in, a computing device consistent with computing device 200, coupled to (and in communication with) the network 112. In addition, the communication device 116 may also be considered as including and/or as being implemented in at least one computing device consistent with computing device 200. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, payment account credentials, transaction data, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 and/or other computer system components configured to perform one or more of the various operations herein. It should be appreciated that the memory 204 may include a variety of different memories, each implemented in one or more of the functions or processes described herein.

In the exemplary embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information (e.g., payment confirmation messages, etc.), visually, for example, to a user of the computing device 200, etc. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user (i.e., user inputs) such as, for example, inputs by the consumer 114, as described herein, etc. The input device 208 may include a single input device or multiple input devices. The input device 208 is coupled to (and is in communication with) the processor 202 and may include, for example, one or more of a keyboard, a pointing device, a mouse, a touch sensitive panel (e.g., a touch pad or a touch screen, etc.), a near field communication reader, another computing device, and/or an audio input device, etc. Further, in various exemplary embodiments, a touch screen, such as that included in a tablet, a smartphone, or similar device, may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC™) adapter, a Bluetooth™ adapter, etc.), a mobile network adapter, or other device capable of communicating to one or more different networks, including the network 112. In some exemplary embodiments, the computing device 200 may include the processor 202 and one or more network interfaces incorporated into or with the processor 202.

Referring again to FIG. 1, in the system 100, the PSP 106 is associated with the wallet platform 120, thereby enabling one or more wallet applications offered by the wallet platform 120 (i.e., wallet application 118), or other wallet applications associated with the wallet platform 120, to be paired with the PSP 106 as described herein. Specifically, the PSP 106 is configured to call an API associated with the wallet platform 120, for example, whereby data associated with the pairing(s) may be exchanged between the PSP 106 and the wallet platform 120 (e.g., to facilitate a payment account transaction for the consumer 114 at one of the merchants 102a-d, etc.).

That said, in the illustrated embodiment, to pair the wallet application 118 associated with the consumer 114 with the PSP 106, the consumer 114 initially accesses the wallet platform 120, via a website (through the network 112), where the wallet platform 120 is configured to provide the website (or, where the payment network 108 or another entity is configured to provide the website). Specifically, the consumer 114 may access the website and then login and/or otherwise authenticate or identify himself/herself to the wallet platform 120, for example, via a username, password, biometric, code, etc. Thereafter, the wallet platform 120 is configured to provide an option for the consumer 114 to pair the wallet application 118 with the PSP 106 (and/or one or more other PSPs). For example, when the consumer 114 indicates a desire to pair the wallet application 118 with the PSP 106, the wallet platform 120 is configured to solicit, via the website, a selection of the wallet application 118 associated with the consumer 114 (e.g., via a wallet account registry (e.g., a phone number, email address, etc.), etc.). The wallet platform 120 is configured to then solicit, via the website, a selection of the PSP 106 (either by directly selecting the PSP 106 or by selection of one or more merchants (e.g., one or more of the merchants 102a-d, etc.) associated with the PSP 106). When each selection is provided (potentially along with other information (e.g., payment account credentials for the consumer's payment account (e.g., a primary account number (PAN), etc.), a shipping address, loyalty account information, etc.), the wallet platform 120 is configured to receive a request from the consumer 114, via the website, to pair the wallet application 118 with the PSP 106.

While the above description makes reference to a “website” provided by the wallet platform 120, it should be appreciated that the wallet platform 120 may further (or alternatively) be configured to provide a network-based application (which may be included in the wallet application 118, or separate therefrom) to pair the wallet application 118 with the PSP 106.

Additionally in the system 100, or alternatively, the consumer 114 may seek to pair the wallet application 118 with the PSP 106 through a payment account transaction. For example, when performing a payment account transaction with the merchant 102a (through a virtual location associated with the merchant 102a), the consumer 114 may submit a request to pair the wallet application 118 with the PSP 106, via the virtual location associated with the merchant 102a, where the request is then passed to the PSP 106 by the merchant 102a, or directly transmitted to the PSP 106 through an API called by the merchant's virtual location. In either case, the request may default to the specific merchant 102a and PSP 106 (as generally associated with the merchant 102a and the merchant's virtual location), or permit the consumer 114 to select additional merchants and/or PSPs. The selected or default merchant(s) and PSP(s) are then identified in the request, along with the consumer's wallet application 118 to be paired. The PSP 106, in turn, is configured to submit the request for the pairing to the wallet platform 120 through a pairing API exposed by the wallet platform 120.

Once the wallet platform 120 receives the pairing request, regardless of how the request is provided, the wallet platform 120 is configured to respond to the request by submitting a further request, to the consumer 114, for consent to pair the merchant 102a and/or the PSP 106 with the wallet application 118. When the consumer 114 provides consent, via the wallet application 118, at the communication device 116, the consent is received at the wallet platform 120. In response, the wallet platform 120 is configured to generate a secure pairing token for the merchant 102a (and/or for the PSP 106). Generating the secure paring token may include, for example, generating a transaction ID for the consumer 114, which includes generating an alpha-numeric string, for example, and other necessary information as the pairing token to thereby facilitate the pairing (or, generating the secure pairing token may include other conventional operations). The transaction ID may be representative of the consumer's consent to share the payment account credential(s) for the consumer's payment account, as included in the wallet application 118 (or provisioned thereto) (or for other payment accounts associated with the wallet application 118), with the merchant 102a and/or the PSP 106. The wallet platform 120 is configured to then either store the pairing token in a database associated with the wallet application 118 (e.g., at the wallet platform 120, at the wallet application 118, or elsewhere, etc.) or store the pairing token in a browser extension (or plugin) (e.g., a Chrome™ extension, etc.) (and associated with the wallet platform 120), or to transmit the pairing token (e.g., the transaction ID, etc.) to the PSP 106. When the pairing token is transmitted to the PSP 106, the PSP 106 is configured to then store the pairing token in memory (e.g., memory 204 associated therewith, etc.) in connection with the consumer 114, the wallet application 118 and/or the consumer's payment account issued by the issuer 110.

Subsequently in the system 100, when the consumer 114 seeks to perform a transaction with the merchant 102a, or one of the other merchants 102b-d (as associated with the PSP 106), the respective merchant (merchant 102a, for example) is configured to provide the option to pay with the wallet application 118. Upon selection of the option by the consumer 114, the merchant 102a is configured to invoke a wallet checkout for the transaction, whereby a separate user interface (or checkout interface, etc.) may be displayed to the consumer 114 on top of the merchant's website (e.g., the Masterpass™ web user interface, etc.) (e.g., as caused by the wallet platform 120, or as associated with selection of the browser extension, etc.). In doing so, the merchant 102a (e.g., the merchant's website, etc.) is configured to call the PSP 106 (e.g., as part of a request that the consumer 114 desires to invoke the checkout, etc.).

When the pairing token for the consumer 114 (as previously generated by the wallet platform 120) is stored at the PSP 106 (e.g., when the wallet platform 120 is generally integrated with the PSP 106 and/or has previously transmitted the pairing token to the PSP 106, etc.), the PSP 106 is configured to call the wallet platform 120 (and, for example, as described more below, pass the pairing token for the consumer 114 to the wallet platform 120). In response, the wallet platform 120 is configured to receive the pairing token associated with the wallet application 118 from the PSP 106, and validate the token (e.g., compare the received pairing token to the pairing token stored at the wallet platform 120, of via other conventional operations, etc.). After validating the pairing token, the wallet platform 120 is configured to pass profile data related to the consumer 114, shipping information, loyalty information, payment information, transaction information for the instant transaction, etc. (e.g., as requested, obtained, etc. from the consumer 114 during the consumer's initial pairing request; as requested, obtained, etc. from the wallet application 118; etc.) to the PSP 106, through the separate user interface (e.g., the Masterpass™ web user interface, etc.) displayed to the consumer 114, at the communication device 116 (e.g., via the API, etc. in this example). The user interface, for example, provides transaction details to the consumer 114 for the given transaction at the merchant 102a (e.g., an item name, item image, price of the item, shipping details, tax, fees, merchant name, merchant URL, etc.) and allows the consumer 114 to confirm payment information (e.g., an account number, etc.). Such transaction details may be provided by the PSP 106 (as part of the information provided to the PSP 106 by the wallet platform 120 and/or the wallet application 118). In addition, within the separate user interface, the consumer 114 may be provided the option to select the payment account (or multiple payment accounts) included in the wallet application 118 for use in the transaction, shipping options (e.g., different shipping addresses, etc.), different loyalty accounts, etc., as passed from the wallet platform 120 to the consumer 114 as the profile data. The consumer 114 is then able to select the desired options from the profile data, and the wallet platform 120, in turn, is configured to pass the consumer's selections (including the selected payment account credential(s)) and other profile data to the PSP 106.

Alternatively, when the pairing token for the consumer 114 (as previously generated by the wallet platform 120) is stored in the browser extension by the wallet platform 120 (e.g., when the wallet platform 120 is not integrated (or at least not fully integrated) with the PSP 106, etc.), the wallet application 118 is configured to retrieve the pairing token from the browser extension and validate the pairing token. After validating the pairing token, the wallet application 118 is configured to pass profile data related to the consumer 114, shipping information, loyalty information, payment information, transaction information for the instant transaction, etc. to the PSP 106, through the separate user interface (e.g., the Masterpass™ web user interface, etc.) displayed to the consumer 114, at the communication device 116. The user interface, for example, provides transaction details to the consumer 114 for the given transaction at the merchant 102a (e.g., an item name, item image, price of the item, shipping details, tax, fees, merchant name, merchant URL, etc.) and allows the consumer 114 to confirm payment information (e.g., an account number, etc.). Such transaction details may be scraped from the merchant's website via the browser extension, etc. In addition, within the separate user interface or within the merchant's website as affected by the browser extension, the consumer 114 may be provided the option to select the payment account (or multiple payment accounts) included in the wallet application 118 for use in the transaction, shipping options (e.g., different shipping addresses, etc.), different loyalty accounts, etc., as passed from the wallet platform 120 to the consumer 114 as the profile data. The consumer 114 is then able to select the desired options from the profile data, and the wallet platform 120, in turn, is configured to pass the consumer's selections (including the selected payment account credential(s)) and other profile data to the PSP 106.

Finally, in either of the above cases, the PSP 106 is configured to submit the transaction to the payment network 108, for example, as is conventional. Specifically, the PSP 106 generates and/or transmits an authorization request to the acquirer 104 for the transaction, which is then passed to the issuer 110 via the payment network 108. The issuer 110 is configured to approve or decline the transaction (again, as is conventional). When approved (or declined), a corresponding authorization reply is passed back to the PSP 106 via the payment network 108 and the acquirer. The PSP 106 is configured to then cause the approval (or decline) for the transaction to be displayed to the consumer 114 (as the consumer 114 is generally returned to the merchant's website, etc.). Upon approval, the merchant 102a is configured to arrange for delivery of the purchased product(s) and to notify the consumer 114 of the successful transaction.

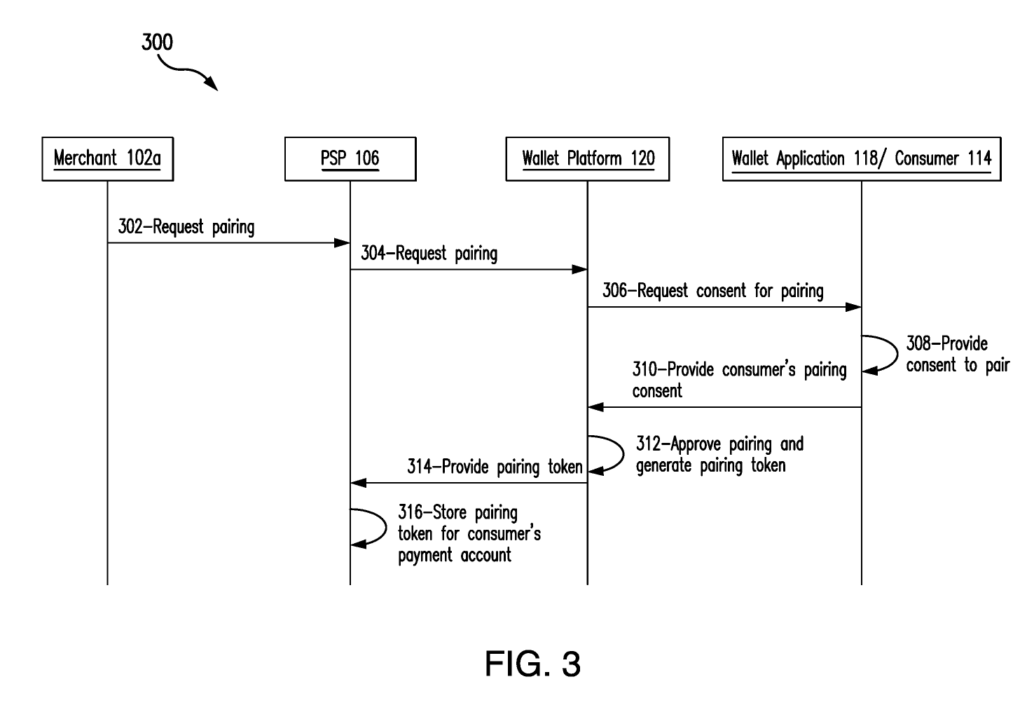

FIG. 3 illustrates an exemplary method 300 for use in pairing an electronic wallet for a consumer with a payment service provider. The exemplary method 300 is described with reference to the system 100, and as implemented generally in the PSP 106, the wallet application 118 and the wallet platform 120. The method 300 is also described with reference to the computing device 200. That said, however, the methods herein should not be understood to be limited to the system 100 or the computing device 200, as the methods may be implemented in other systems and/or computing devices. Likewise, the systems and the computing devices herein should not be understood to be limited to the exemplary method 300.

In order to pair the PSP 106 with the wallet application 118 in the illustrated method 300, the consumer 114 initially requests the paring in connection with a payment account transaction at the merchant 102a (e.g., via a website or network-based application associated with the merchant 102a, etc.). In connection therewith, the request is submitted by the merchant 102a, at 302, to the PSP 106 in connection with the transaction, or as a specific paring operation/request through the merchant 102a. Or, the pairing request may be submitted in response to any other interaction with the merchant 102a (i.e., those omitting a particular transaction). Alternatively, and as described above in connection with the system 100, the request may be provided at the direction of the consumer 114 through a web site or network-based application associated with the wallet platform 120 and/or the PSP 106 (whereby the pairing request may originate from the consumer 114 directly, instead of via the merchant 102a, via the PSP 106 and/or wallet platform 120). In any case, in soliciting the pairing request, the consumer 114 may be asked to select/identify the wallet application 118 to be paired with the merchant 102a and/or the PSP 106 (where the merchant 102a and/or the PSP 106 are provided as a default parameter for the request), or the consumer 114 may be asked to specify one or more PSPs (e.g., the PSP 106, etc.) and may be asked to select one or more merchants (e.g., one or more of the merchants 102a-d, etc.) to be associated with the resulting pairing request (where the merchants are generally associated with the specified one or more PSPs).

Once the pairing request is submitted, it is received by the PSP 106. In turn, the PSP 106 transmits, at 304, the pairing request to the wallet platform 120 (where, as described above, the wallet platform 120 may be a standalone part of the system 100 or it may be associated with the payment network 108). The wallet platform 120 then requests, at 306, consent from the consumer 114, via the wallet application 118, for the pairing. In one example, a consent interface is displayed at the communication device 116 (e.g., at the presentation unit 206 thereof, etc.) (e.g., where the consent interface appears within the Masterpass™ web application user interface or included in the Masterpass™ user interface as controlled by the browser extension described above, etc.). The consent interface includes an indication of the particular merchant 102a and, potentially, the PSP 106, and one or more of the other merchants 102b-d also associated with the PSP 106, for which the paring would be imposed (e.g., the pairing may be imposed for all merchants associated with the indicated PSP 106, or the pairing may be imposed for only particular merchants selected, approved, etc. by the consumer 114; etc.). In response, the consumer 114 provides the requested consent, at 308 (e.g., by checking a consent box, by selecting an “ACCEPT” button, etc. in the consent interface, at the wallet application 18, etc.). And, the wallet application 118 provides the consumer's pairing consent back to the wallet platform 120, at 310.

Upon receipt of the consent from the consumer 114, the wallet platform 120 approves the pairing of the wallet application 118 and the PSP 106, and generates a secure pairing token, at 312. The pairing token may include (among other things), as described above, a transaction ID that is specific to the consumer 114 (e.g., an alphanumeric string that represents consent by the consumer 114 to pair his/her payment account with the wallet application 118 and to share such information with the PSP 106 at checkout, etc.), the wallet application 118, the wallet platform 120 and/or the PSP 106. And, at 314, the wallet platform 120 provides the pairing token to the PSP 106, along with one or more indicators of the consumer 114, the wallet application 118 and/or the communication device 116. The PSP 106 then stores the pairing token, at 316, in memory (e.g., in a data structure of memory 204 associated therewith, in association with the wallet application 118, etc.) along with the one or more indicators (whereby the one or more indicators may subsequently be used to retrieve the paring token from the memory as needed).

Alternatively in the method 300, when the wallet platform 120 provides the pairing token to the PSP 106 (at 314), the wallet platform 120 may also store the pairing token (including the transaction ID for the consumer 114, etc.) within the browser extension (e.g., in association with the wallet application 118, etc.). This may help facilitate a transaction by the consumer 114 in the event, for example, that the PSP 106 is not fully integrated with the wallet application 118 and/or wallet platform 120, whereby the browser extension may provide the available payment options for the consumer 114 for the transaction and the consumer 114 may then facilitate payment for the transaction by selection of the available payment option(s) at the browser extension.

While method 300 is described with reference to the merchant 102a, it should be appreciated that the method 300 may be initiated by any of the other merchants 102b-d associated with the PSP 106 and follow, generally, the same operation to provide a secure pairing token to the PSP 106 that is suitable for use with one or more of the merchants 102a-d.

In addition, in various implementations of the method 300, the pairing token described herein may expire after one or more intervals. For example, a pairing token associated with the pairing of the wallet application 118 and the PSP 106 may expire at 10 days, 20 days, 30 days, 60 days, or at a longer or shorter time. As such, the method 300 may be repeated from time to time to ensure the pairing between the wallet application 118 and the PSP 106 is up to date and valid (and the multiple merchants 102a-d associated therewith).

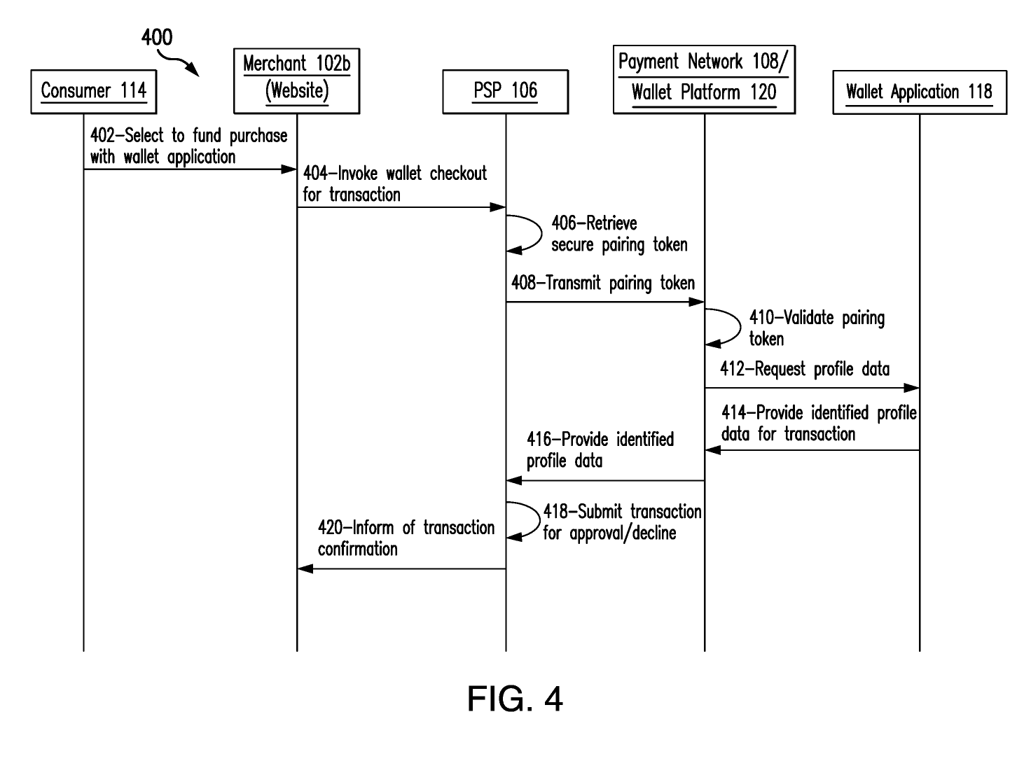

FIG. 4 illustrates an exemplary method 400 for use in facilitating a payment account transaction based on a token associated with an electronic wallet paired with a payment service provider. The exemplary method 400 is described with reference to the system 100, and as implemented generally in the PSP 106, the wallet application 118, and the wallet platform 120. The method 400 is also described with reference to the computing device 200. That said, however, the methods herein should not be understood to be limited to the system 100 or the computing device 200, as the methods may be implemented in other systems and/or computing devices. Likewise, the systems and the computing devices herein should not be understood to be limited to the exemplary method 400.

The method 400 is also described with reference to the merchant 102b, and assumes that a secure paring token for the wallet application 118 and/or a payment account associated with the wallet application 118 is provided to and stored in the PSP 106 (and is valid). That said, it should be appreciated that the method 400 is similarly suited to involve the merchants 102a, 102c and/or 102d.

When the consumer 114 browses products at a virtual location associated with the merchant 102b (e.g., via the merchant's website, etc.), the consumer 114 may decide to purchase one or more of the products. To do so, the consumer 114 may interact with the merchant 102b, via the virtual location (or merchant's website), in a variety of manners, but, ultimately, at some point, selects, at 402, to fund a purchase for the product(s) with the paired wallet application 118. In one example, the consumer 114 may generally select to purchase the product(s) (e.g., the consumer 114 may generally select a shopping cart icon at the merchant's website, etc.). In another example, the consumer 114 may specifically select to purchase the product(s) with the wallet application 118 (e.g., the consumer 114 may specifically select to “Purchase with Masterpass® wallet,” etc.). In either case, in response to the selection, the merchant 102b invokes, at 404, a wallet checkout for the transaction. Specifically, the virtual location of the merchant 102b passes one or more details of the transaction (e.g., product description, transaction amount, consumer name, wallet application ID, etc.) to the PSP 106 through an API call or similar operation. In connection therewith, a user interface may be displayed to the consumer 114 on top of the merchant's virtual location.

When the pairing token for the consumer's wallet application 118 is stored in the PSP 106 (e.g., in a data structure associated therewith, etc.), the PSP 106 then, at 406, retrieves the token for the pairing between wallet application 118 and the PSP 106 and transmits, at 408, the token to the wallet platform 120. In turn, the wallet platform 120 validates the pairing token, at 410, as received from the PSP 106. The validation may be completed by the wallet platform 120 (and/or, potentially, by the payment network 108 when the wallet platform 120 is associated with the payment network 108). In general, however, the token is validated to determine that the received token was originally generated by the wallet platform 120 and/or to determine that the token is not expired. Once validated, in this example, the wallet platform 120 identifies and requests profile data from the consumer 114, via the wallet application 118, at 412, based on the pairing token (e.g., to ensure that up-to-date information is used in the interaction, etc.). The profile data may include the payment account associated with the wallet application 118, the shipping address for the consumer 114, loyalty accounts associated with the consumer 114, etc. (and known to the wallet application 118 and/or wallet platform 120). The profile data is then presented to the consumer 114 (via a user interface), such that the consumer 114 is able to identify and/or select among different options included in the profile data for use in the given transaction (e.g., to select among multiple payment accounts, shipping addresses, loyalty accounts, etc.) (or potentially enter another).

And, in connection therewith, the consumer 114 confirms, identifies, etc. the profile data to be used for the given transaction, via the user interface (e.g., based on the data provided by the wallet application 118 to the wallet platform 120, etc.). Then in the method 400 (in this implementation when the pairing token for the consumer's wallet application 118 is stored in the PSP 106), the wallet application 118, and specifically, the communication device 116, provides, at 414, the requested profile data for the transaction back to the wallet platform 120. The wallet platform 120, in turn, provides the identified, confirmed, etc. profile data to the PSP 10, at 416. In this example, the identified profile data includes, for example, the payment account credential(s) for the payment account selected by the consumer 114, the shipping address, and the loyalty account (if any), etc. Finally, the PSP 106 submits, at 418 (via an authorization request), the transaction for approval or decline from the issuer 110 of the consumer's payment account (or other entity associated with the issuer 110) (e.g., via the acquirer 104, the payment network 108, etc. as is generally conventional). The issuer 110 (or other entity) responds to the authorization request by either approving or declining the transaction. When approved, the PSP 106 informs the consumer 114 of the transaction confirmation, at 420, thereby permitting delivery of the product(s) purchased.

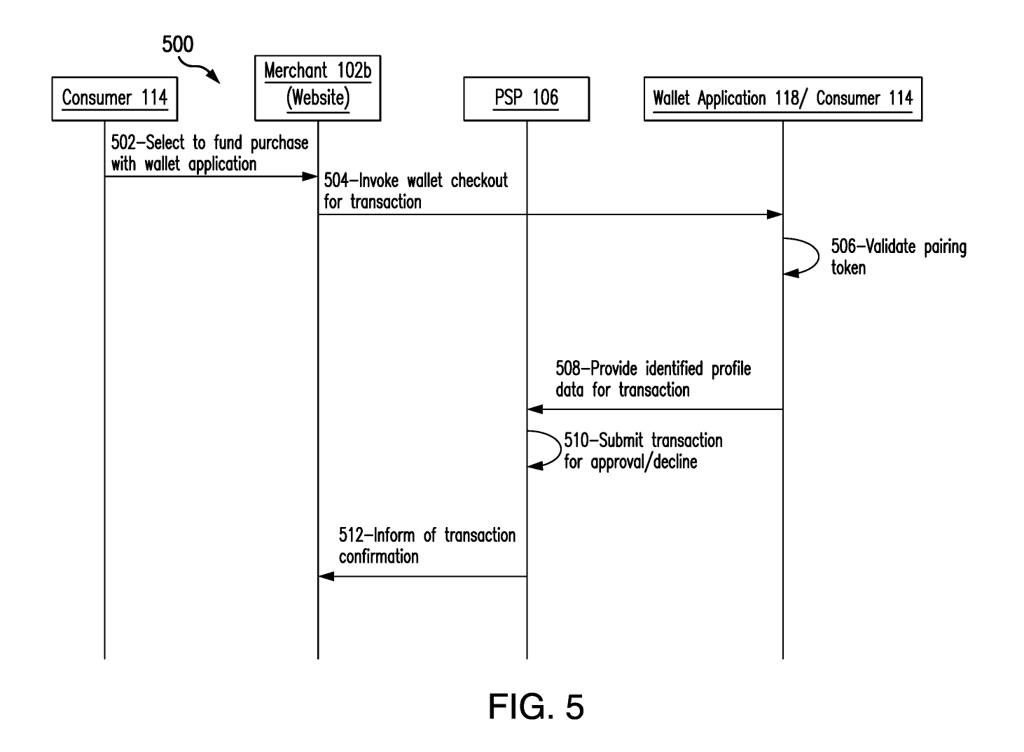

FIG. 5 illustrates exemplary method 500 for use in facilitating a payment account transaction based on a token associated with an electronic wallet paired with a payment service provider. The method 500 is substantially similar to method 400, but represents a variation thereof in which the pairing token is stored in the browser extension and used to facilitate the given transaction by the consumer 114.

In method 500, when the consumer 114 browses products at the virtual location associated with the merchant 102b, the consumer 114 may decide to purchase one or more of the products. To do so, the consumer 114 selects, at 502, to fund a purchase for the product(s) with the paired wallet application 118 (similar to operation 402 described above with reference to FIG. 4). In response to the selection, the merchant 102b invokes, at 504, a wallet checkout for the transaction (similar to operation 404 described above with reference to FIG. 4). Specifically, the virtual location of the merchant 102b passes one or more details of the transaction (e.g., product description, transaction amount, consumer name, wallet application ID, etc.) to the PSP 106 through an API call, via web scraping by the browser extension, or similar operation. In connection therewith, a user interface may again be displayed to the consumer 114 on top of the merchant's virtual location (by the browser extension, in this example, detecting the merchant's virtual location and the consumer 114 clicking the browser extension).

In this embodiment (e.g., as compared to the example embodiment of method 400, etc.), the PSP 106 may not be fully integrated with the wallet application 118 and/or wallet platform 120. As such, the pairing token stored in the browser extension may be used to facilitate the transaction by the consumer 114 (instead of the pairing token being transmitted by the PSP 106 to the wallet platform 120). In particular in this example, the wallet application 118 validates, at 506, the pairing token as included in the browser extension (and, in particular, the transaction ID associated therewith). And, when the pairing token is validated (and consumer consent remains in place and has not expired), the consumer 114 confirms, identifies, selects, etc. the desired profile data to be used for the given transaction (e.g., via the user interface or via the merchant's website as affected by the browser extension, etc.) (e.g., to thereby initiate the transaction, etc.). The wallet application 118, in turn, provides the identified profile data to the PSP 106, at 508. In this example, the identified profile data includes, for example, the payment account credential(s) for the payment account selected by the consumer 114, the shipping address, and the loyalty account (if any), etc. Finally, the PSP 106 submits, at 510 (via an authorization request), the transaction for approval or decline from the issuer 110 of the consumer's payment account (or other entity associated with the issuer 110) (e.g., via the acquirer 104, the payment network 108, etc. as is generally conventional). The issuer 110 (or other entity) responds to the authorization request by either approving or declining the transaction. When approved, the PSP 106 informs the consumer 114 of the transaction confirmation, at 512, thereby permitting delivery of the product(s) purchased.

In view of the above, the systems and methods herein permit consumers to pair electronic wallets, for example, with the PSPs, whereby payment account credentials included in the electronic wallets are usable at different merchants associated with the PSPs (without requiring multiple different profiles with the different merchants). In so doing, the consumers may specify such service for all merchants associated with the PSPs, or for only select ones of the merchants (e.g., as selected by the consumers, etc.). What's more, in the systems and methods herein the electronic wallets need not be separately paired with each of the individual merchants in order to facilitate desired transactions at the merchants, but instead can be generally paired with the PSPs (where such pairing operations may be performed independent of one or more of the merchants, but where the electronic wallets (after such paring) can still be used at the one or more of the merchants (even when the one or more merchants are not separately paired with the electronic wallets)).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving, by a computing device, a request to pair a wallet application with a service provider (e.g., a payment service provider (PSP), etc.), the wallet application associated with an account (e.g., a payment account, etc.), and the account associated with a user; (b) requesting, by the computing device, consent from the user to pair the wallet application with the service provider; (c) upon consent from the user, generating, by the computing device, a pairing token for the wallet application and the service provider; (d) storing the pairing token in association with the wallet application, whereby the service provider is permitted to use the pairing token in a subsequent network transaction involving an entity (e.g., a merchant, etc.) associated with the service provider and the wallet application, regardless of whether the wallet application is separately paired with the entity; (e) validating, by the computing device, the pairing token in connection with the subsequent transaction involving the wallet application and the entity associated with the PSP; (f) receiving, by the computing device, identification of at least one payment account and at least one shipping address for the subsequent transaction; and (g) providing, by the computing device, profile data to the PSP for the subsequent transaction, the profile data including the at least one payment account and the at least one shipping address.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for pairing a wallet application for a user with a service provider, the method comprising:
receiving, by a computing device, a request to pair a wallet application with a service provider, the wallet application associated with an account, and the account associated with a user;
requesting, by the computing device, consent from the user to pair the wallet application with the service provider;
upon consent from the user, generating, by the computing device, a pairing token for the wallet application and the service provider; and
storing the pairing token in association with the wallet application, whereby the service provider is permitted to use the pairing token in a subsequent network transaction involving an entity associated with the service provider and the wallet application, regardless of whether the wallet application is separately paired with the entity.

2. The computer-implement method of claim 1, wherein the service provider includes a payment service provider (PSP); and
wherein storing the pairing token includes transmitting, by the computing device, the pairing token to the PSP.

3. The computer-implement method of claim 2, wherein the pairing token includes an alpha-numeric string of characters.

4. The computer-implemented method of claim 2, further comprising validating, by the computing device, the pairing token in connection with the subsequent transaction involving the wallet application and the entity associated with the PSP.

5. The computer-implement method of claim 4, further comprising:
receiving, by the computing device, identification of at least one payment account and at least one shipping address for the subsequent transaction; and
providing, by the computing device, profile data to the PSP for the subsequent transaction, the profile data including the at least one payment account and the at least one shipping address.

6. The computer-implemented method of claim 1, wherein the service provider is a payment service provider (PSP) and wherein the entity associated with the PSP is a first merchant; and
wherein receiving the request to pair the wallet application with the PSP includes receiving the request via a virtual location associated with a second merchant, whereby the PSP is permitted to use the pairing token in the subsequent network transaction involving the first merchant even though the request to pair the wallet application with the PSP is received via the second merchant.

7. The computer-implemented method of claim 1, wherein storing the pairing token includes storing the pairing token in a data structure coupled to the computing device.

8. The computer-implemented method of claim 1, wherein storing the pairing token includes storing the pairing token in a browser extension, the browser extension configured to recognize a virtual location associated with the entity in connection with facilitating the subsequent network transaction.

9. The computer-implemented method of claim 1, wherein receiving the request includes soliciting from the user, by the computing device, a selection of the wallet application and a selection of the service provider.

10. The computer-implemented method of claim 1, wherein receiving the request includes soliciting from the user, by the computing device, a selection of the wallet application and a selection of at least one entity associated with the service provider.

11. A system for pairing a wallet application for a user with a payment service provider, the system comprising:
a memory; and
a processor coupled to the memory, the processor configured to:
receive a request from a user to pair a wallet application with a payment service provider (PSP), the request including an indication of the wallet application and an indication of the PSP;
request consent from the user to pair the wallet application with the PSP;
when the user provides the consent, generate a pairing token for the wallet application and the PSP; and
store the pairing token in the memory in association with the wallet application, whereby the PSP is permitted to use the pairing token in a subsequent payment account transaction involving a merchant associated with the PSP and involving the wallet application, regardless of whether the wallet application is separately paired with the merchant.

12. The system of claim 11, wherein the processor is further configured to transmit the pairing token to the PSP.

13. The system of claim 12, wherein the processor is further configured to:
receive the pairing token from the PSP in connection with a checkout request by the user initiated at the merchant in connection with a payment account transaction;
validate the received pairing token; and
when the received pairing token is validated, receive, from the wallet application, identification of at least one payment account and at least one shipping address for the payment account transaction.

14. The system of claim 13, wherein the processor is further configured to transmit the at least one payment account and the at least one shipping address to the PSP.

15. The system of claim 14, wherein the merchant is a first merchant; and
wherein the processor is configured, in connection with receiving the request from the user to pair the wallet application with the PSP, to receive the request via a virtual location associated with a second merchant, whereby the PSP is permitted to use the pairing token in the subsequent network transaction involving the first merchant even though the request to pair the wallet application with the PSP is received via the second merchant.

16. The system of claim 11, wherein the processor is further configured to store the pairing token in a browser extension, the browser extension configured to recognize a virtual location associated with the merchant in connection with the user facilitating a payment account transaction at the merchant.

17. A computer-implemented method for facilitating a payment account transaction via a wallet application paired with a payment service provider, the method comprising:
receiving, by a computing device, a pairing token from a payment service provider (PSP) in connection with a checkout request by a user initiated at a merchant associated with the PSP in connection with a payment account transaction by the user at the merchant;
validating, by the computing device, the received pairing token;
when the received pairing token is validated, receiving, by the computing device, from the wallet application, identification of at least one payment account and at least one shipping address for use in the payment account transaction; and
transmitting the at least one payment account and the at least one shipping address to the PSP.

18. The computer-implemented method of claim 17, further comprising:
displaying a user interface to the user; and
soliciting from the user, via the user interface, confirmation of the at least one payment account and at least one shipping address for use in the payment account transaction prior to transmitting the at least one payment account and the at least one shipping address to the PSP.

19. The computer-implemented method of claim 18, wherein receiving the pairing token from the PSP in connection with the checkout request by the user includes receiving the pairing token from the PSP in connection with the checkout request by the user via a virtual location associated with the merchant; and
wherein displaying the user interface to the user includes displaying the user interface to the user in association with the virtual location associated with the merchant.
